(19) United States
(12) Patent Application Publication
(10) Pub. No.: US 2024/0351470 A1
(43) Pub. Date: Oct. 24, 2024

(54) POWER MANAGEMENT APPARATUS FOR MULTIPLE POWER SUPPLY VEHICLES

(71) Applicant: Consolidated Metco, Inc., Vancouver, WA (US)

(72) Inventor: Bret Hunley, Vancouver, WA (US)

(21) Appl. No.: 18/641,878

(22) Filed: Apr. 22, 2024

Related U.S. Application Data
(60) Provisional application No. 63/461,484, filed on Apr. 24, 2023.

(51) Int. Cl. B60L 58/12; B60L 3/00

(52) U.S. Cl. CPC B60L 58/12; B60L 3/0046; B60L 2240/547; B60L 2240/549

(57) ABSTRACT

In one aspect, a vehicle power management apparatus including power distribution circuitry operatively connecting a primary power supply input, a primary external power source input, a recovery component output, and a standard component output. The power distribution circuitry has an operating configuration wherein the power distribution circuitry electrically connects the primary power supply input to the recovery component output and the standard component output and inhibits a flow of electrical power from the primary external power source input to the recovery component output. The power distribution circuitry has a recovery configuration wherein the power distribution circuitry electrically connects the primary external power source input to the recovery component output and inhibits a flow of electrical power from the primary power supply input to the standard component output and the recovery component output.

### CROSS-REFERENCE TO RELATED APPLICATION

This application claims the benefit of U.S. Provisional Application No. 63/461,484, filed Apr. 24, 2023, which is hereby incorporated herein by reference in its entirety.

### TECHNICAL FIELD

This disclosure relates to vehicle systems and, more specifically, to vehicle systems that employ multiple power supplies.

### BACKGROUND

Various types of vehicles rely on multiple electrical power supplies to provide power to various electrically powered devices of the vehicle. One type of such a vehicle is a tractor-trailer wherein the trailer includes an electrically powered device. An example of an electrically powered device of a trailer is a trailer refrigeration unit (TRU) that cools a storage area of the trailer.

Trailers, including those with a TRU, traditionally have a diesel generator that operates to charge an on-board battery. To reduce fossil fuel consumption, some battery trailer systems have a plug or socket for electrically connecting the system to a plug-in charging station. The plug or socket of the trailer is often proprietary to the manufacturer of the trailer or the battery system, which may preclude charging of an empty battery if the driver of the vehicle is unable to locate a corresponding plug-in charger along the truck route.

Another issue with existing trailer battery systems that utilize a plug-in charger is that such systems employ a control system powered by a control battery separate from the battery used to power the operational equipment, e.g. a compressor of the TRU. Once the control battery has a charge that falls below a set minimum voltage, the control system shuts off and the trailer battery system is inoperable until the trailer battery system is connected to a plug-in charger that can recharge the control battery. Other problems arise where the control system operates electric motors of a trailer (e.g., of a regenerative braking system) and the control system loses power and is unable to operate the electric motors. For example, some electric motors have a feature referred to as automatic short circuit (ASC) where the AC coils of the electric motor are shorted when electric power or CAN bus communication is lost. Problems arise when the trailer is towed by a tractor when the electric motors are in ASC and not being operated by the control system, for example, the electric motors may overheat and become damaged.

### SUMMARY

In one aspect of the present disclosure, a power management apparatus for a vehicle is provided. The power management apparatus includes a primary power supply input to receive electrical power from a primary power supply of the vehicle and a primary external power source input to receive electrical power from a primary external power source of the vehicle. For example, the vehicle may include a trailer, the primary power supply may include a battery of the trailer, and the primary external power source may include an anti-lock brake system of a tractor associated with the trailer.

The power management apparatus includes a recovery component output to provide electrical power to a recovery component of the vehicle and a standard component output to provide electrical power to a standard component of the vehicle. The recovery component may be a vehicle component, such as vehicle control unit and/or battery charging circuitry, that requires electrical power to operate and facilitate operation of another component of the vehicle. The standard component may be a component controlled by a recovery component and/or a component that may be energized after the recovery component has restarted operation of another component of the vehicle.

The power management apparatus further includes power distribution circuitry operatively connecting the primary power supply input, the primary external power source input, the recovery component output, and the standard component output. The power distribution circuitry has an operating configuration wherein the power distribution circuitry: electrically connects the primary power supply input to the recovery component output and the standard component output to provide electrical power from the primary power supply to the recovery component and the standard component. In the operating configuration, the power distribution circuitry also inhibits a flow of electrical power from the primary external power source input to the recovery component output. In this manner, during normal operation of the vehicle, the power distribution circuitry permits the recovery and standard components to receive electrical power from the primary power supply while keeping the recovery component from drawing power from the primary external power source.

The power distribution circuitry has a recovery configuration wherein the power distribution circuitry electrically connects the primary external power source input to the recovery component output to provide electrical power from the primary external power source to the recovery component. In the recovery configuration, the power distribution circuitry also inhibits a flow of electrical power from the primary power supply input to the standard component output and the recovery component output. The power distribution circuit in the recovery configuration thereby permits the recovery component to receive electrical power from the primary external power source and facilitate operation of the recovery component despite the primary power source being unable to power the recovery component. As an example in this regard, a recovery component (e.g., a vehicle control unit) can receive power from the primary external power source (e.g., an anti-lock brake system of a tractor) to facilitate charging of the primary power source (e.g., a battery of the vehicle) that normally provides electrical power to the vehicle control unit even when the primary power source has been depleted.

The present disclosure also provides a vehicle, such as a trailer, tractor-trailer, straight truck, or box van. The vehicle includes a primary power supply, a primary external power source interface to be connected to a primary external power source, a recovery component, and a standard component, and a power management apparatus. Based at least in part upon electrical power being available from the primary power supply for the recovery component and the standard component, the power management apparatus is configured to: facilitate the recovery component and the standard component receiving electrical power from the primary power supply; and inhibit a flow of electrical power from the primary external power source interface to the recovery component. The power management apparatus thereby permits the recovery component and the standard component to receive electrical power from the primary power supply when the primary power supply is able to provide sufficient electrical power to the recovery component and the standard component.

Based at least in part upon electrical power being unavailable from the primary power supply for the recovery component and the standard component, the power management apparatus is configured to: facilitate the recovery component receiving electrical power from the primary external power source interface; and inhibit a flow of electrical power from the primary power supply to the recovery component and the standard component. In this manner, the power management apparatus permits the recovery component to be energized via the primary external power source when the primary power supply is depleted or otherwise unavailable.

The present disclosure also provides a method for managing power of a vehicle that includes a primary power supply, a recovery component, a standard component, and a primary external power source. The method includes determining whether electrical power is available from the primary power supply of the vehicle to power the standard component and the recovery component. The method includes facilitating the standard component and the recovery component receiving electrical power from the primary power supply and inhibiting flow of electrical power from the primary external power source to the recovery component based at least in part upon the electrical power being available from the primary power supply to power the standard component and the recovery component. The method further includes facilitating the recovery component receiving electrical power from the primary external power source and inhibiting flow of electrical power from the primary power supply to the recovery component and the standard component based at least in part upon the electrical power being unavailable from the primary power supply to power the standard component and the recovery component.

### BRIEF DESCRIPTION OF THE DRAWINGS

FIG. 1A is a perspective view of a tractor-trailer.

FIG. 1B is a block diagram of a power management system of the trailer.

FIG. 2 is a partial circuit diagram of the power management system of FIG. 2.

FIGS. 3-6 are a flow diagram of an operational method for the power management system of FIG. 1.

FIG. 7 is a partial circuit diagram of a power management system according to another embodiment.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

In one aspect, the present disclosure provides a vehicle having a vehicle control unit, a primary power supply for powering the vehicle control unit, a secondary power supply, and a power management system that enables charging of the primary power supply from the secondary power supply. When the primary power supply has an adequate capacity, the vehicle control unit is able to control the flow of electricity to various electrically powered devices of the vehicle.

The power management system is configured to search for external power sources for the primary and secondary power supplies to enable recharging of the primary power supply when any of the external power sources are present. In this manner, the primary power supply may be recharged via the secondary power supply or external power sources to enable operation of the vehicle control unit rather than the vehicle control unit becoming inoperable once the primary power supply has inadequate capacity.

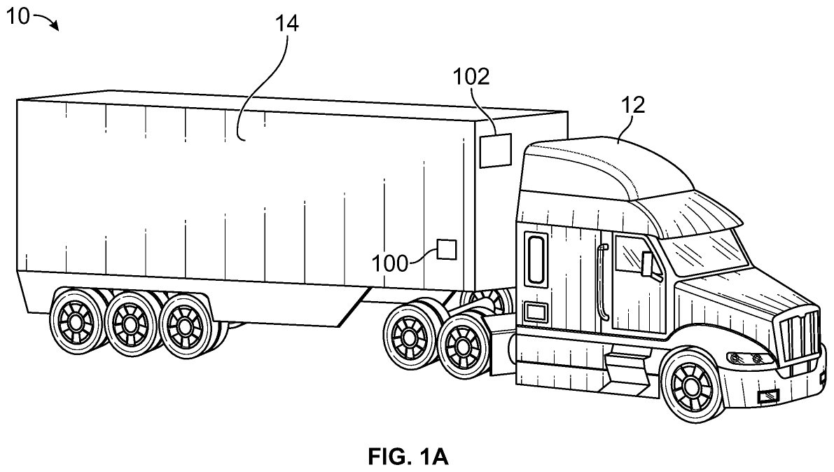

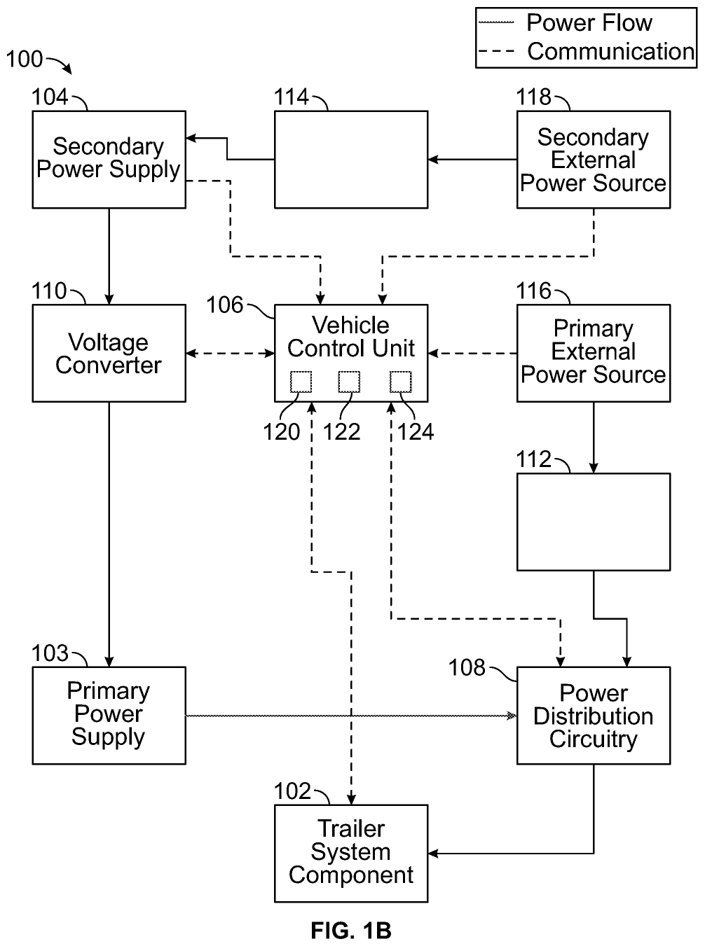

With reference to FIGS. 1A and 1B, a vehicle 10 is shown that includes a tractor 12 and a trailer 14. The trailer 14 has a power management system 100 shown in detail in FIG. 1B. While a tractor-trailer is discussed below, those having skill in the art will readily appreciate that the disclosures herein may be applied to various vehicles such as a box truck, cube van, locomotive, rail car, intermodal shipping container, cement mixer, mobile crane, recreational vehicle (RV), pumper or vacuum truck, mobile police or government agency command center, filmmaking support vehicle, or food truck, as some examples. While the vehicle 10 is a tractor-trailer in the discussion below, it should be appreciated that the vehicle 10, in another embodiment, may be the trailer 14 independent of the tractor 12.

The power management system 100 includes a trailer system component 102, a primary power supply 103, a secondary power supply 104, a vehicle control unit (VCU) 106, and a power distribution circuitry 108. The primary power supply 103 and the secondary power supply 104 can include batteries that store power as Direct Current (DC), but other types of power sources such as a super capacitor are also possible. In some embodiments, the secondary power supply 104 outputs a higher voltage than the primary power supply 103. For example, the primary power supply 103 may include a 12V or a 24V battery and the secondary power supply 104 may include a 400V or 800V battery of a regenerative braking and/or propulsion system of the trailer system component 102. The trailer system component 102 can include one or more components of the trailer that utilize power from the primary power supply 103 and/or the secondary power supply 104. Examples of the trailer system component 102 include a TRU, an electric motor, a global navigation satellite system receiver, a powered liftgate, pallet truck charger, a pump, a resistance heater, electronic device, and/or a vacuum.

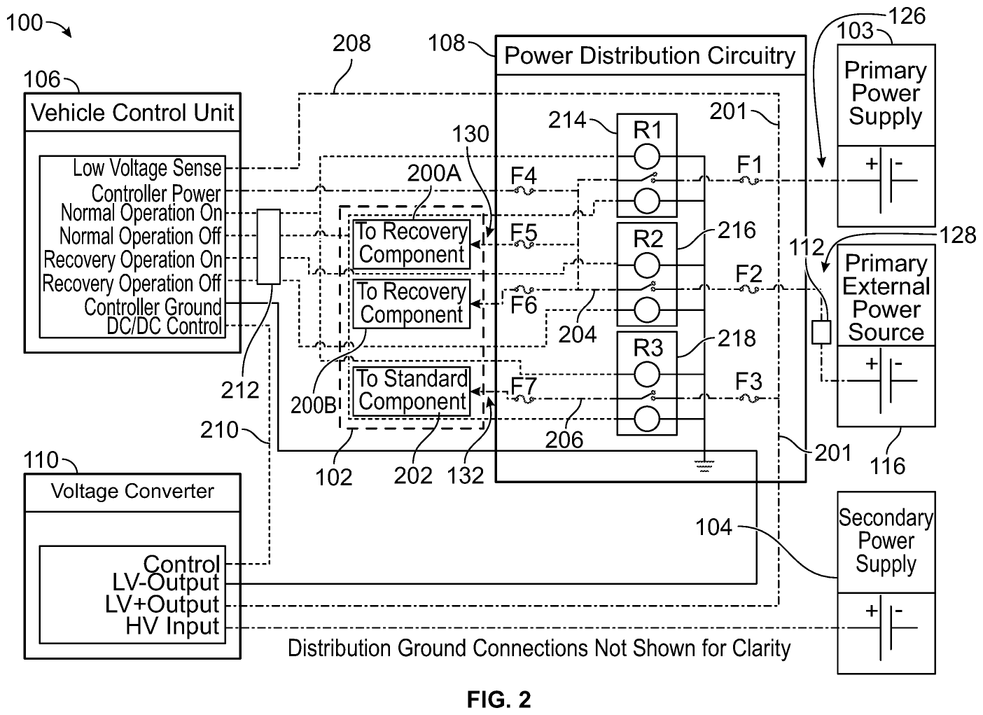

Regarding FIG. 1B, the primary power supply 103 can be electrically coupled to the power distribution circuitry 108 to form a primary voltage bus 201 (see FIG. 2) that is used to distribute power to the trailer system components 102. The power distribution circuitry 108 contains multiple control and distribution circuits for the purpose of power distribution in a controlled and managed manner to the trailer system components 102 as discussed in more detail below. Furthermore, the primary power supply 103 is configured to be rechargeable in several ways. For example, by the secondary power supply 104 at the direction of the VCU 106, the use of “jump start” posts on the primary power supply 103 or through some other external power source. In embodiments where the secondary power supply 104 outputs a higher voltage than the primary power supply 103, the power management system 100 can also include a voltage converter 110 that, when activated by the VCU 106, is configured to step down the higher voltage level of the secondary power supply 104 to the lower voltage level of the primary power supply 103. The voltage converter 110 can include a DC-to-DC converter. In embodiments where the voltage level of the secondary power supply 104 and the primary power supply 103 are equivalent, a switch can be used in place of the voltage converter 110 to enable the VCU 106 to control coupling and decoupling together of the secondary power supply 104 and the primary power supply 103 for charging purposes. In embodiments where the secondary power supply 104 outputs a lower voltage than the primary power supply 103, the power management system 100 can also include a voltage converter 110 that, when activated by the VCU 106, is configured to step up the lower voltage level of the secondary power supply 104 to the higher voltage level of the primary power supply 103. The voltage converter 110 can include a DC-to-DC converter.

The power management system 100 also includes a primary external power source interface 112 and a secondary external power source interface 114. The primary external power source interface 112 can be configured to electrically couple a primary external power source 116 to the power distribution circuitry 108 and the secondary external power source interface 114 can be configured to electrically couple a secondary external power source 118 to the secondary power supply 104. As used herein, the term “external power source” is intended to cover power sources outside of a storage and conversion circuit that includes the primary power supply 103, the secondary power supply 104, the VCU 106, the power distribution circuitry 108, the primary external power source interface 112, the secondary external power source interface 114, and, if present, the voltage converter 110. The secondary external power source 118 can take the form of an offboard charger (e.g. a Level 1, 2, or 3 electric vehicle charger); a regenerative braking system motor that operates as a generator; a constant or clutched generator connected to a wheel end; a shore power source; a cord or socket that connects to the local power grid; a heat recovery system of the exhaust system of the vehicle; a dynamic energy recovery system such as shocks of a cab of the tractor; or some other type of power source.

The primary external power source 116 can include a connection to the tractor 12 or similar unit responsible for locomotion of the trailer 14. The primary external power source 116 can include a reliable and repeatable power source such as a SAE J560 center pin, blue wire, typically used for powering an anti-lock braking system (ABS) of a trailer or pin 6, brown wire, in the ISO 3731 supplemental trailer connection used for switched tractor ignition power. In these embodiments, the primary external power source 116 is live or conducting electricity when the vehicle is on or running and continues to conduct electricity until the vehicle is turned off, which may be referred to as “ignition power”.

The VCU 106 constitutes a main logical control unit of the power management system 100, meaning that the VCU 106 is responsible for logical control and management of the power management system 100 as well as the trailer system component 102. The VCU 106 may include a processor 120 and memory 122. The processor 120 may execute programs and functions stored in the memory 122 to control operations of the vehicle 10 as discussed herein. The processor 120 may include, as examples, a microprocessor, an application-specific integrated circuit (ASIC), or a field programmable gate array (FPGA). The memory 122 may include, as examples, random-access memory (RAM), read-only memory (ROM), electrically erasable programmable read-only memory (EEPROM), and flash memory. As shown in FIG. 1B, the VCU 106 can include electrical communication connections with the secondary power supply 104, the voltage converter 110 (if present), the trailer system component(s) 102, the power distribution circuitry 108, the primary external power source 116. The VCU 106 may include a communication interface 124 operable by the processor 120 to communicate with the other components of the vehicle 10 to send commands to and/or receive data from the components. As examples, the VCU 106 may communicate with the other components of the vehicle 10 using analog communication (e.g., discrete control wiring), serial communication (e.g., RS485), and/or a Controller Area Network (CAN bus) (e.g., J1939). In some embodiments, the VCU 106 can electrically communicate with the primary external power source 116 and the secondary external power source 118 via connections through the primary external power source interface 112 and the secondary external power source interface 114, respectively.

In general operation, the VCU 106 monitors variables of the power management system 100 such as the voltage level of the primary power supply 103 and/or the secondary power supply 104 and/or the presence or non-presence of power from the primary external power source 116 or the secondary external power source 118. In response to identifying that current values of the variables and/or changes in these variables indicate that a charging state is present, the VCU 106 is configured to enable charging of the primary power supply 103 via the secondary power supply 104. In response to identifying that current values of the variables and/or changes in the variables indicate that a reset state is present, the VCU 106 is configured to disable charging of the primary power supply 103 via the secondary power supply 104. Furthermore, the VCU 106 is configured to direct the power distribution circuitry 108 to alter power distribution to the trailer system components 102 based on whether the current values variables and/or changes in the variables indicate that a recovery state or a normal state is present. The VCU 106 may include transistors (e.g., field-effect transistors) operable by the processor 120 to output control signals from the VCU 106 to control the state of the power distribution circuitry 108.

Turning now to FIG. 2, in some embodiments the trailer system component 102 can include recovery components 200A and 200B and standard components 202. The recovery components 200A and 200B along with the VCU 106 are electrically coupled to a recovery component bus 204 of the power distribution circuitry 108 and the standard components 202 can be coupled to a standard component bus 206 of the power distribution circuitry 108. The recovery components 200A and 200B are key operating components of the trailer 14. For example, components that operate various safety features of the trailer 14 and/or components that facilitate charging of the primary power supply 103 and/or the secondary power supply 104. Examples of the recovery components 200A, 200B include battery charging circuitry, power conversion circuitry (e.g., voltage converter 110), safety monitoring devices (e.g., vehicle inclination sensing devices, vehicle roll sensing devices, vehicle impact sensing devices, a high voltage interlock loop (HVIL), etc.), isolation monitors, user feedback components (e.g., displays, lights, etc.).

The standard components 202 include operational components that less important to operation of the trailer 14, such as those that do not need to be active while the primary power supply 103 and/or the secondary power supply 104 are not at or near full operating capacity. Some examples of standard components 202 include lights, pumps, fans, displays, electric power take-offs (ePTO), and propulsion motors. Separating out the recovery components 200A and 200B from the standard components 202 reduces the electrical load when the recovery component bus 204 is coupled to the primary external power source 116.

Furthermore, the VCU 106 is electrically coupled to a voltage sense interface 208, which in turn is coupled to the primary voltage bus 201 so that a voltage level at the voltage sense interface 208 as measured by the VCU 106 reflects a current voltage level of the primary voltage bus 201. A secondary voltage sensor that communicates the voltage value of the primary voltage bus 201 to the VCU 106 can also be used. The VCU 106 can additionally be coupled to a charging control interface 210 for facilitating charging of the primary power supply 103 (e.g. via activating the voltage converter 110) and a power distribution unit interface 212 for directing the operation of the power distribution circuitry 108.

With continued reference to FIG. 2, the power management system 100 includes a primary power supply input 126 to receive electrical power from the primary power supply 103 and provide electrical power to the primary voltage bus 201. The power management system 100 includes a primary external power source input 128 to receive electrical power from the primary external power source 116. The power management system 100 further includes a recovery component output 130 to provide electrical power to the recovery components 200A, 200B. The power management system 100 includes a standard component output 132 connected to the standard components 202 to provide electrical power to the standard components 202. As examples, the primary power supply input 126, the primary external power source input 128, the recover component output 130, and the standard component output 132 may include wires, cables, wire harnesses, busbars, electrical connectors, circuit board traces, or other electrical conductors.

In some embodiments the power distribution circuitry 108 includes a component relay 214, a recovery relay 216, and a secondary relay 218. The component relay 214 is electrically coupled between the recovery component bus 204 and the primary voltage bus 201. The recovery relay 216 is electrically coupled between the recovery component bus 204 and the primary external power source interface 112. The secondary relay 218 is electrically coupled between the standard component bus 206 and the primary voltage bus 201. The component relay 214, the recovery relay 216, and the secondary relay 218 can be either bi-stable relays such as shown in FIG. 2 or spring return relays. Spring return relays can be used for components of the power management system 100 that are activated in certain instances. Bi-stable relays are typically used for primary power buses such as the primary voltage bus 201. The component relay 214, the recovery relay 216, and the secondary relay 218 may also be configured in a series configuration.

In some embodiments, fuses F1, F2, and F3 can be electrically coupled in line between the primary voltage bus 201 and the component relay 214, the recovery relay 216, and the secondary relay 218, respectively. Similarly, fuses F4, F5, and F6 can be electrically coupled in line between the recovery component bus 204 and the VCU 106, the recovery components 200A, and the recovery components 200B, respectively. A fuse F7 can be electrically coupled in line between the standard component bus 206 and the standard components 202. Each of the fuses F1, F2, F3, F4, F5, F6, and F7 can provide overcurrent protection to the component relay 214, the recovery relay 216, and the secondary relay 218 and other elements of the power management system 100. Specifically, each of the fuses F1, F2, F3, F4, F5, F6, and F7 can break to initiate an open circuit when a current level flowing through the fuse F1, F2, F3, F4, F5, F6, or F7 exceeds a maximum current value associated therewith. In some embodiments, some or all of the fuses F1, F2, F3, F4, F5, F6, and F7 may be replaced or supplemented by other current limiting devices such as circuit breakers, metal-oxide-semiconductor field-effect transistors (MOSFETs), etc.

In operation, the VCU 106 provides two major functions. First, the VCU 106 senses the voltage level of the primary voltage bus 201 via the voltage sense interface 208. In some embodiments, the VCU 106 actively and constantly measures the voltage level of the primary voltage bus 201. Furthermore, the voltage sense interface 208 can be located at a position that is close to where the primary power supply 103 is coupled to the primary voltage bus 201 to ensure that the voltage measurement closely reflects the current voltage level of the primary power supply 103. In one approach, the voltage sense interface 208 includes an electrical cable having a gauge and length configured to minimize resistance within the electrical cable. In some embodiments, an electrical cable of approximately 1 meter (3 ft) in length and having an American Wire Gauge (AWG) value of around 15-17 (e.g. a cross-sectional area around 1-1.7 square mm) is used. This electrical cable can produce a resistance value of approximately 0.008-0.016 Ohms. Additionally or alternatively, in some embodiments, the VCU 106 is configured to account for any resistance in the electrical cable by performing a calibration process so that a voltage reading taken by the VCU 106 is within a preselected tolerance.

The second major function provided by the VCU 106 is control. Specifically, the VCU 106 will make logical control decisions for the power management system 100 based at least in part upon the voltage measurement at the voltage sense interface 208. This control can include directing other components of the power management system 100 to turn ON or OFF and/or manipulating components inside the power distribution circuitry 108 to change how power is distributed and/or how much power is consumed by the various components. In some embodiments, measurement of the voltage level of the primary voltage bus 201 and the primary power supply 103 can be accomplished by other measurement devices that communicate the measured voltage level to the VCU 106 and/or the power distribution circuitry 108 accordingly.

When operating the power distribution circuitry 108, the VCU 106 is configured to set the component relay 214 to an ON position (e.g., electrically coupling the recovery component bus 204 to the primary voltage bus 201) any time the voltage measured at the voltage sense interface 208 is deemed to be within a predetermined acceptable range. When the voltage is in the acceptable range, the VCU 106 is additionally configured to set the recovery relay 216 into an OFF state (e.g., electrically decoupling the recovery component bus 204 from the primary external power source interface 112). The component relay 214 receives power directly from primary voltage bus 201. The primary voltage bus 201 is powered either by the primary power supply 103 or the secondary power supply 104 via the voltage converter 110. The recovery relay 216 receives power from the primary external power source interface 112. The component relay 214 and recovery relay 216 are operated opposite of each other by the VCU 106 such that if the component relay 214 is closed, recovery relay 216 is open and vice versa. Components on the circuit with the component relay 214 and recovery relay 216 are critical components to the power management system 100. Components not critical to controlling operation of the trailer 14 are placed in series or parallel with additional relays (e.g., the secondary relay 218). As shown in FIG. 2, the component relay 214, the recovery relay 216, and the secondary relay 218 are operated using a positive trigger signal from the VCU 106. However, a negative control scheme is also possible. If a negative scheme is used, coils of the component relay 214, the recovery relay 216, and the secondary relay 218 are connected to the recovery component bus 204 and the VCU 106 supplies a ground signal to the coils to actuate the component relay 214, the recovery relay 216, and the secondary relay 218. Diodes and other circuit and power management components known in the art may be utilized as needed to manage power distribution in the power management system 100.

The primary external power source 116 can take several forms including a typical Society of Automotive Engineers (SAE) J560 electrical connection between a trailer and tractor (e.g. the recommended electrical interface for all North American trailers.) The SAE J560 electrical connection consists of power wires, switched power wires, and grounds. In some embodiments, the center pin, blue wire, of the SAE J560 that is typically used to power the ABS of the trailer can be utilized as the primary external power source 116. In operation, the center pin of the SAE J560 is present and operating to provide power when the tractor 12 is powered ON (e.g. “ignition power” is active). In some embodiments, the center pin is wired “HOT” or direct to a low voltage battery source of the tractor 12 and is not switched by powering on the tractor 12. In this embodiment, an ISO 3731 plug is used and the ABS source is transitioned there. For alternative configurations of trailer or tractor where the SAE J560 center pin is not the ignition power source, the primary external power source 116 is connected to whichever circuit line also powers the ABS unit of the trailer 14. In some embodiments, the power management system 100 can also tap into other circuit lines within the primary external power source interface 112 (e.g., an J560 interface, ISO 3731 interface, or an ISO 12098 interface) for monitoring and/or control purposes. Additionally, the VCU 106 and other components of the power management system 100 that are connected to the primary external power source interface 112 are configured so as not to disrupt a Power Line Carrier (PLC) signal used to communicate ABS related data. Detecting the presence of the primary external power source 116 is a trigger for several different operations based on the current state of the vehicle. For example, the presence of current from the primary external power source 116 indicates that the tractor 12 is present and running. The trailer system components 102, the VCU 106, and/or the power distribution circuitry 108 may determine that the tractor 12 is ready for motion and that there is available power in response to the presence of current from the primary external power source 116.

The secondary external power source 118 is utilized to recharge and maintain operation of the secondary power supply 104 and any components of the trailer powered by the secondary power supply 104. The secondary external power source 118 can take many forms such as stationary, mobile, and/or hybrid. The stationary form can include an offboard “shore power” plug or cord, an electric vehicle charger such as a Level 1, 2, or 3 chargers, megawatt chargers, power storage banks, and/or an on-site generator. When connected to the secondary external power source interface 114, the secondary external power source 118 actively recharges the secondary power supply 104 while the trailer 14 is stationary.

The mobile embodiments of the secondary external power source 118 can take the form of an on-vehicle electric or diesel/gas generator, motor, e-axle, dynamic energy harvesting system such as a system that converts movement of the cab of the tractor 12 into electric energy, and/or a thermal energy harvesting system such as a system that uses the high temperatures of the exhaust of the tractor 12 into electricity. In the example where the secondary external power source 118 includes a regenerative braking system of the vehicle 10, the VCU 106 or other control system of the trailer can activate a motor of the regenerative braking system to apply torque to the wheels, axles, etc. of the trailer 14 which is in turn generates electricity used to charge the secondary power supply 104. As such, the mobile form of the secondary external power source 118 can actively recharge the secondary power supply 104 while the trailer 14 is in motion.

The secondary external power source 118 may include a power source that is active in both stationary and mobile modes of the vehicle 10. These sources may be attached to the trailer 14 and generate power for the secondary power supply 104 by harvesting energy from the environment such as solar or wind power. In some embodiments, the various forms of the secondary external power source 118 can include communication channels with the secondary power supply 104 and/or the VCU 106 to coordinate the charging operation.

When the trailer system component 102 is active, the primary power supply 103 can be charged by the secondary power supply 104 unit through the voltage converter 110 powering the primary voltage bus 201. When trailer system component 102 is inactive, the stored power of the primary power supply 103 will be consumed to maintain monitoring functions of the power management system 100 and at some point the voltage of the primary power supply 103 decrease to a level where power management is needed.

When the voltage of the primary power supply 103 reaches a lower limit such as below, equal to, or within a percentage of a predetermined voltage, the VCU 106 initiates a first level of action to enable the secondary power supply 104 to recharge the primary power supply 103. In one example, when the voltage at the voltage sense interface 208 reaches a specific trigger point, the VCU 106 enables the secondary power supply 104 and the voltage converter 110 to supply voltage to the primary voltage bus 201. In response, the voltage on the primary voltage bus 201 will come up to a charge level for the primary power supply 103 and will be held at the charge level to allow the primary power supply 103 to recharge. As discussed in more detail below, the charging can be for a specified amount of time, until the secondary power supply 104 has been depleted below a threshold level, or until some other trigger condition is reached.

Because the primary voltage bus 201 is being actively powered by the secondary power supply 104 and the voltage converter 110 during a charging operation, measurement at voltage sense interface 208 will not reflect a charge state of the primary power supply 103. As such, if a state of charge measurement of the primary power supply 103 is needed during the charging operation, the measurement is done within the primary power supply 103 or in some other manner that does not read the voltage level off of the primary voltage bus 201. In some embodiments, a state of charge measurement for either the primary power supply 103 or the secondary power supply 104 corresponds to a voltage level within the primary power supply 103 or secondary power supply 104 respectively. For example, for a standard 12V battery, an approximately 20% state of charge for the battery corresponds to about 10.8-11V and a 0% state of charge corresponds to approximately 10.5V. However, the exact voltage values can vary based on the battery in use and the chemistry it contains.

Once the specified amount of time for charging is concluded, the secondary power supply 104 is depleted below the corresponding threshold level, or the power level within the primary power supply 104 is deemed to be at an acceptable level, and the trailer system component 102 is still inactive, the VCU 106 can deactivate the charging cycle by turning the secondary power supply 104 and/or the voltage converter 110 to an OFF state. This cycle of depletion and charging of the primary power supply 103 will continue until the secondary power supply 104 falls below the corresponding storage threshold. Once that limit is reached, the secondary power supply 104 and voltage converter 110 will remain in the OFF state until the charge level of the secondary power supply 104 is increased beyond the corresponding threshold level.

As part of the operating methods described herein, the VCU 106 is configured to determine when the primary external power source 116 is able to provide electrical power to the primary external power source interface 112 and when the secondary external power source 118 is able to provide electrical power to the secondary external power source interface 114. Various methods to determine these conditions are possible. For example, the VCU 106 can be configured to communicate with the primary external power source 116 and the secondary external power source 118 via the primary external power source interface 112 and secondary external power source interface 114, respectively, to determine the presence and availability of electrical power. Furthermore, in some embodiments, the VCU 106 is configured to measure a voltage level at input terminals of the primary external power source interface 112 and the secondary external power source interface 114 to determine the ability of the primary external power source interface 112 and the secondary external power source interface 114 to provide electrical power.

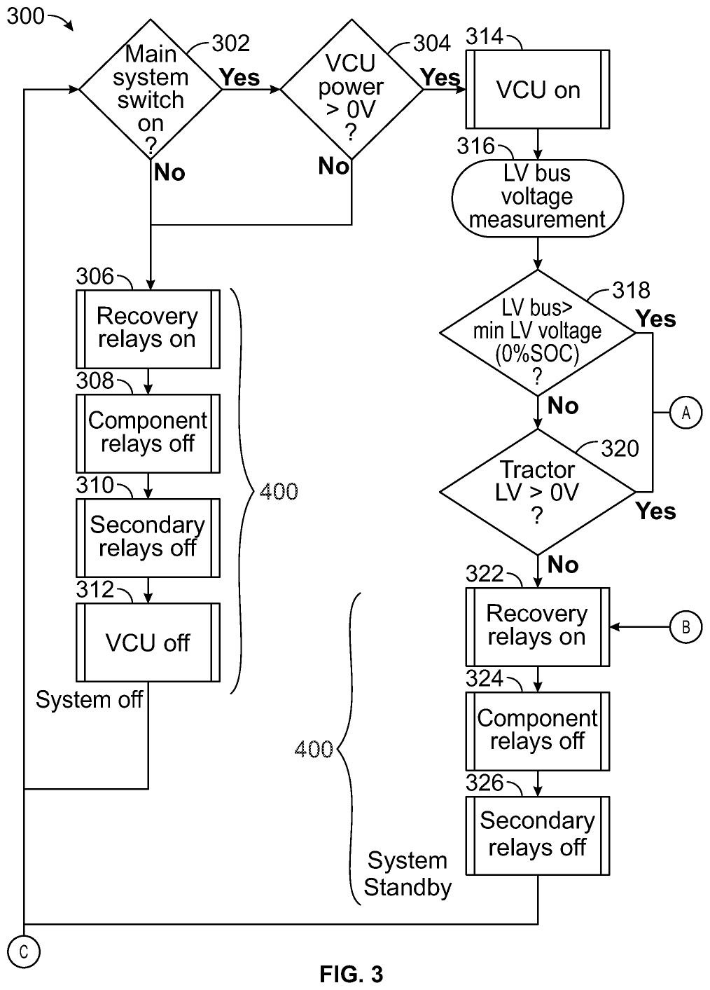

With reference to FIGS. 3-5, an operating method 300 is provided for the power management system 100. The operation of the power management system 100 can be divided into five separate operating modes including: a system off mode, a system standby mode, a tractor support mode, a high voltage support mode, and a normal operation mode. During each of the operating modes of the power management system 100, the power management system 100 may have different states including a recovery state 400, a normal state 402, a charging state 404, and a reset state 406.

The VCU 106 operates the power management system 100 between each of the different modes based on different identified conditions of the power management system 100. These conditions can include the status of a main system switch, a presence of power to the VCU 106, the voltage level at the voltage sense interface 208, a presence of a voltage at the primary external power source interface 112 from the primary external power source 116, a state of charge of the secondary power supply 104, a status of a recovery timer, and/or a presence of a voltage at the secondary external power source interface 114 from the secondary external power source 118. The rate at which the power management system 100 cycles through each of the different operating modes and transitions from each different measurement may be set according to a time period sufficient for the power management system 100 to reach a steady state environment. For example, the time period can be less than approximately 2-5 seconds.

The operating method 300 begins by checking 302 on the status of the main system switch and checking 304 for the presence of power to the VCU 106. When the results of either the checking 302 or the checking 304 indicate that the main or master system switch is OFF or that there is no power to the VCU 106, respectively, the power management system 100 enters the system off mode. The master system switch can take many different forms but has at least two distinct, mechanical or electrical latching positions, i.e., ON and OFF. As shown in FIG. 3, when in the system off mode, the VCU 106 can identify the recovery state 400 as present and direct the power distribution circuitry 108 to electrically decouple the recovery component bus 204 and the standard component bus 206 from the primary voltage bus 201, and electrically couple the recovery component bus 204 to the primary external power source interface 112. In particular, the power distribution circuitry 108 can transition 306 the recovery relay 216 to an ON state, transition 308 the component relay 214 to an OFF state, and transition 310 the secondary relay 218 to an OFF state. Then, the operating method 300 can include deactivating 312 the VCU 106. The recovery relay 216 is moved to the ON state to enable power to flow to the recovery components 200A, 200B even while the power management system 100 is in the system off mode. The recovery components 200A, 200B may include telematics systems and systems for monitoring a state of the trailer 14. The power management system 100 can loop in the system off mode until the checking 302 indicates that both the master switch is ON and the checking 304 indicates that the VCU 106 is receiving power.

After exiting the system off mode loop, the operating method 300 can include activating 314 the VCU 106 and measuring 316 voltage at the voltage sense interface 208 by the VCU 106. Then, the operating method 300 can include determining 318 whether the voltage at the voltage sense interface 208 is greater than a minimum voltage level for the voltage sense interface 208 and determining 320 whether the primary external power source 116 is able to provide power to the primary external power source interface 112. When the results of the determining 318 and the determining 320 indicate both that the voltage at the primary voltage bus 201 is less than a minimum voltage level for the voltage sense interface 208 and that the primary external power source 116 is unable to power the primary external power source interface 112, the power management system 100 enters the system standby mode.

Regarding FIG. 3, when in the system standby mode, the VCU 106 can identify the recovery state 400 as present and direct the power distribution circuitry 108 to: 1) electrically decouple the recovery component bus 204 and the standard component bus 206 from the primary voltage bus 201; and 2) electrically couple the recovery component bus 204 to the primary external power source interface 112. In particular, like in the system off mode, the power distribution circuitry 108 in the system standby mode can transition 322 the recovery relay 216 to the ON state, transition 324 the component relay 214 to the OFF state, and the transition 326 the secondary relay 218 to the OFF state. Thus, in the system standby mode, the power management system 100 is enabled by the master system switch being in the ON position; the primary power supply 103 being unable to support the power management system 100 because the voltage output is less than the minimum voltage level (e.g. there is no remaining state of charge, the primary power supply 103 is drained, etc.); and there being no external power source for the primary power supply 103. Because there is no available external power source present in this mode, the standard components 202 are not operated.

The power management system 100 can loop in the system standby mode until the conditions for the system off mode are met, the results of the determining 318 indicate that voltage at the voltage sense interface 208 is greater than the minimum voltage level, or the result of the determining 320 indicates that the primary external power source 116 is able to provide power to the primary external power source interface 112. Thus, the power management system 100 will remain in the standby state until entering the system off mode or until external power is applied to the primary voltage bus 201 in some form (e.g. by replacing the primary power supply 103, charging the primary power supply 103 directly through the use of a battery tender/charger, connecting the trailer 14 to the primary external power source interface 112, and/or powering on the tractor 12 to the ignition state, etc.)

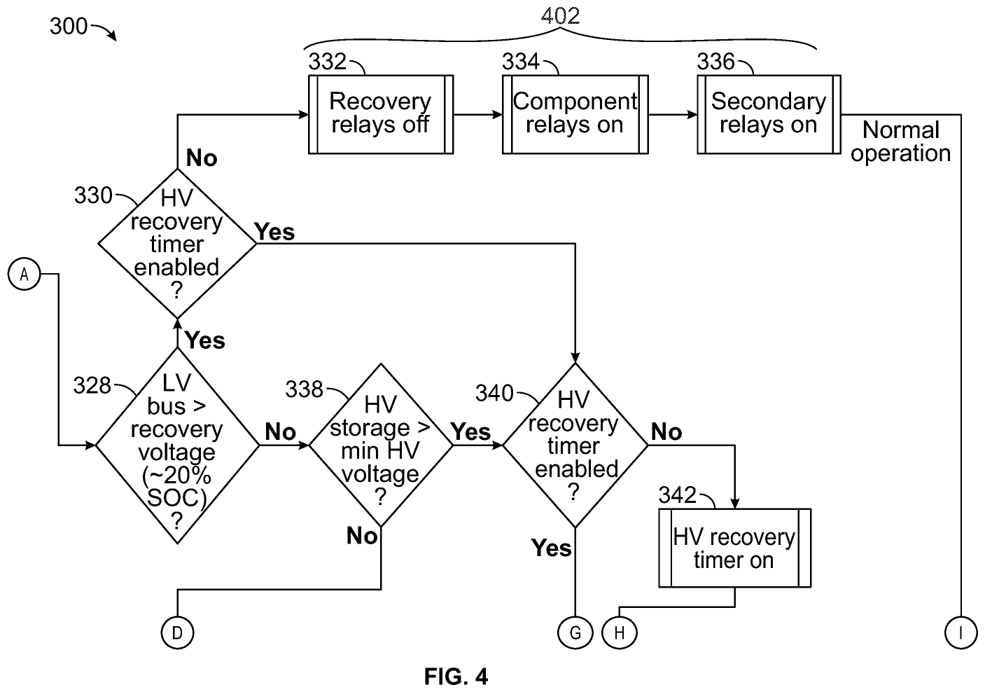

With reference to FIG. 4, when the results of the determining 318 or the determining 320 indicate that voltage at the voltage sense interface 208 is greater than the minimum voltage level (which indicates that a sufficient level of power is available on the primary voltage bus 201) or the primary external power source 116 is able to provide power to the primary external power source interface 112, the VCU 106 can direct the power management system 100 to exit the system standby mode. In particular, the power management system 100 can enter the normal operating mode when a result of a determining operation 328 indicates that the voltage on the voltage sense interface 208 is greater than a recovery voltage threshold and a result of a determining operation 330 indicates to the VCU 106 that a recovery timer has not previously been enabled. In some embodiments, the determining 330 can be omitted or replaced with another similar operation that checks whether the charging state 404 has recently occurred. In some embodiments, the recovery voltage threshold can be approximately 20% of the full state of charge for the primary power supply 103.

When in the normal operating mode, the VCU 106 can identify the normal state 402 as present and direct the power distribution circuitry 108 to electrically couple the recovery component bus 204 and the standard component bus 206 to the primary voltage bus 201, and electrically decouple the recovery component bus 204 from the primary external power source interface 112. In particular, the power distribution circuitry 108 can transition 332 the recovery relay 216 to the OFF state, transition 334 the component relay 214 to the ON state, and the transition 336 the secondary relay 218 to the ON state. As such, the normal operation mode of the power management system 100 is enabled by the master system switch being in the ON position and the primary power supply 103 having a state of charge greater than the recovery voltage threshold. In this state, the state of charge of the secondary power supply 104, presence of the secondary external power source 118, and/or status of any timers are not considered because the power source for the primary voltage bus 201 is the primary power supply 103 and/or the voltage converter 110. In some embodiments, the power management system 100 cycles through the normal operating mode at a rate as defined within the VCU 106 and utilizes stored power from the primary power supply 103 to power devices such as the VCU 106 and trailer system components 102 that require operation. Further, the power management system 100 can loop in the normal operating mode until: 1) the conditions for the system off or system standby modes are met; 2) the determining 328 indicates that the voltage level at the voltage sense interface 208 is less than the recovery voltage; or 3) the determining 330 indicates that the recovery timer is active.

With continued reference to FIG. 4, when the result of the determining 328 indicates that the voltage level at the voltage sense interface 208 is less than the recovery voltage threshold, the operating method 300 can include determining 338 whether a state of charge of the secondary power supply 104 is greater than a preconfigured minimum charge value. Then, when the result of the determining 338 indicates that the state of charge of the secondary power supply 104 is greater than the preconfigured minimum charge value, the VCU 106 can direct the power management system 100 to enter the high voltage support mode. In some embodiments, before the VCU 106 directs the power management system 100 to enter the high voltage support mode, the operating method 300 can include determining 340 whether the recovery timer is enabled and activating 342 the recovery timer when the result of the determining 340 indicates that the recovery timer is not enabled. Further, the VCU 106 can direct the power management system 100 to enter the high voltage support mode when results of the determining 330 indicate that the recovery timer is enabled. As with the determining 330, in some embodiments, the determining 340 can be omitted or replaced with another similar operation that checks whether the charging state 404 has recently occurred. In some embodiments, the preconfigured minimum charge value for the secondary power supply 104 can be in the range of approximately 3% to approximately 10% of the maximum state of charge for the secondary power supply 104, such as approximately 5% of the maximum state of charge value for the secondary power supply 104.

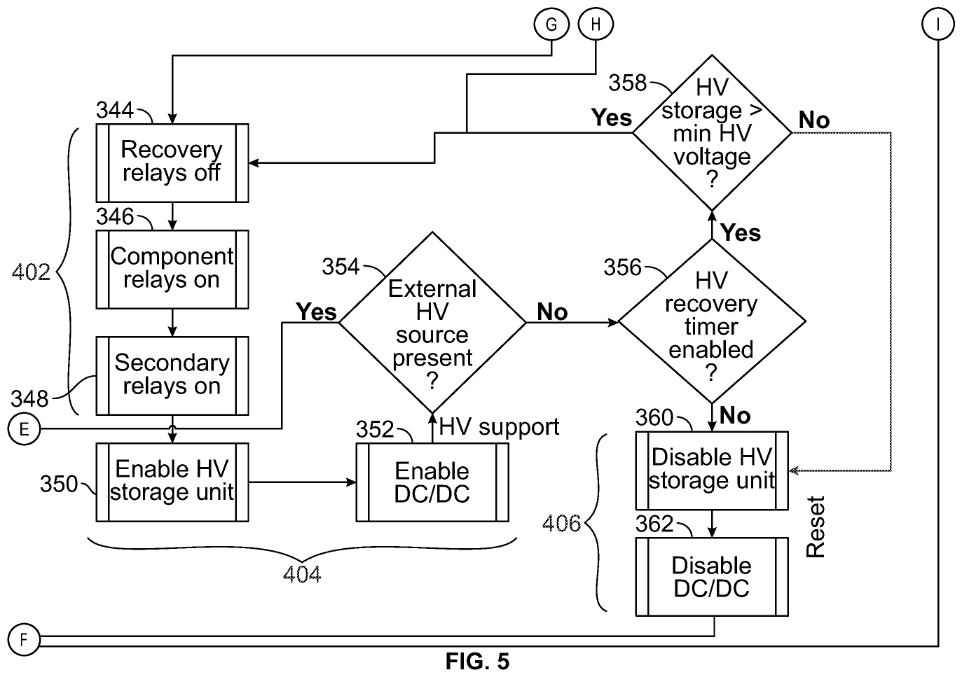

With reference also to FIG. 5, when in the high voltage support operating mode, the VCU 106 can identify the normal state 402 as present and direct the power distribution circuitry 108 to electrically couple the recovery component bus 204 and the standard component bus 206 to the primary voltage bus 201, and electrically decouple the recovery component bus 204 from the primary external power source interface 112. In particular, the power distribution circuitry 108 can transition 344 the recovery relay 216 to the OFF state, transition 346 the component relay 214 to the ON state, and the transition 348 the secondary relay 218 to the ON state. Additionally, when in the high voltage support operating mode, the VCU 106 can identify the charging state 404 as present and enable charging of the primary power supply 103 via the secondary power supply 104. In particular, the operating method 300 can include enabling 350 operation of the secondary power supply 104 and enabling 352 operation of the voltage converter 110. For example, when the VCU 106 identifies that the charging state 404 is present, the VCU 106 can send an enable charging signal to the charging control interface 210 to activate the voltage converter 110 to charge the primary power supply 103 via the secondary power supply 104.

As such, the high voltage support mode is where the power management system 100 is enabled by the master system switch being in the ON position; the primary power supply 103 having a low state of charge remaining; and the secondary power supply 104 having available power. In this operating mode, because the voltage of the primary voltage bus 201 is supplied by the secondary power supply 104 via the voltage converter 110, monitoring of the state of charge of the primary power supply 103 is not possible using the voltage sense interface 208. Therefore, in some embodiments, the recovery timer is implemented to ensure sufficient charging of the primary power supply 103.

The length of the recovery timer is set based on the hardware selected for the primary power supply 103 and the charge rate of the voltage converter 110. In particular, the recovery timer length is set to enable the primary power supply 103 to recharge to a predetermined level above the recovery voltage threshold. For example, in some embodiments, the predetermined level above the recovery voltage threshold can be 90% of the maximum state of charge of the primary power supply 103, which results in a timer requirement of approximately 20 minutes. In some embodiments, the primary power supply 103 does not need to fully reach the preconfigured level above the recovery voltage threshold; rather, it is sufficient that the primary power supply 103 reach a level of charge that is significantly above the recovery voltage threshold. For example, if the recovery voltage threshold is set at 20% and preconfigured level above the recovery voltage threshold is 90%, the length of the recovery timer is calculated to be the time needed for the voltage converter 110 to charge the primary power supply 103 by 70% of the maximum state of charge of the primary power supply 103. Because the voltage threshold for entering the recovery mode is effectively 1-20% of the maximum state of charge of the primary power supply 103 (the combination of the determining operations 318 and 328), this example charge cycle would result in a final charge for the primary power supply 103 that is approximately 71-90% of the maximum state of charge for the primary power supply 103. This means that under the most extreme conditions, there is an approximately 50% buffer between the charged state of the primary power supply 103 and the next occurrence of the high voltage support mode.

After identification of the charging state 404 as part of the high voltage support operating mode, the power management system 100 can loop in the high voltage support mode until the recovery timer expires, the state of charge of the secondary power supply 104 falls below a predetermined minimum charge value for the secondary power supply 104, or the secondary external power source 118 is able to provide power to the secondary external power source interface 114. In particular, the operating method 300 can include, following the identification of the charging state 404 as part of the high voltage support operating mode, determining 354 whether the secondary external power source 118 is connected to the secondary external power source interface 114. The operating method 300 can also include determining 356 whether the recovery timer is still enabled and determining 358 whether the state of charge of the secondary power supply 104 is greater than the preconfigured minimum charge value. With reference to FIG. 5, when the result of the determining 356 indicates that the recovery timer is disabled (e.g. the time limit has expired) and/or the result of the determining 358 indicates that the state of charge of the secondary power supply 104 has fallen below the preconfigured minimum charge value, the VCU 106 can identify the reset state 406 as present and then return to the start of the operating method 300. In particular, the operating method 300 can include disabling 360 of the secondary power supply 104 and disabling 362 of the voltage converter 110. For example, when the VCU 106 identifies that the reset state 406 is present, the VCU 106 can send a disable charging signal to the charging control interface 210 to deactivate the voltage converter 110 to stop charging of the primary power supply 103 via the secondary power supply 104.

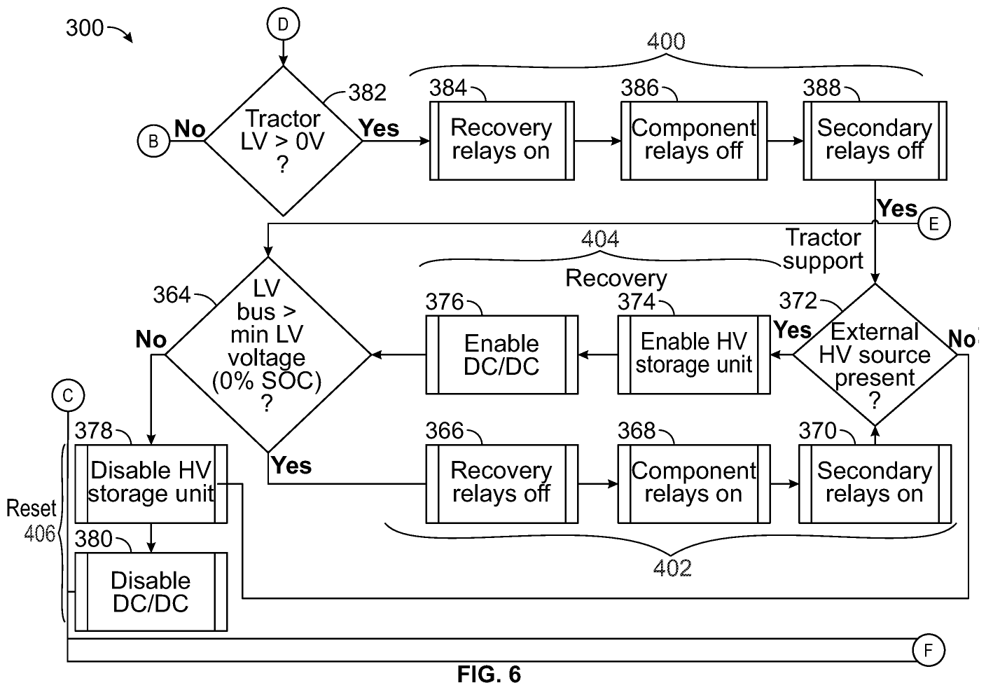

However, when the results of the determining 354 indicate that the secondary external power source 118 is able to provide power to the secondary external power source interface 114, the VCU 106 can direct the power management system 100 to enter the recovery operating mode as shown in FIG. 6. For example, the determining 354 may include determining whether a shore power source is connected to an electrical input of the secondary external power source interface 114, the shore power source configured to provide 400V AC.

When in the recovery operating mode, the operating method 300 can include determining 364 whether the voltage at the voltage sense interface 208 is greater than the minimum voltage level for the voltage sense interface 208. When results of the determining 364 indicate that the voltage at the voltage sense interface 208 is greater than the minimum voltage level for the voltage sense interface 208, the VCU 106 can identify that the normal state 402 is present and direct the power distribution circuitry 108 to electrically couple the recovery component bus 204 and the standard component bus 206 to the primary voltage bus 201, and electrically decouple the recovery component bus 204 from the primary external power source interface 112. In particular, the power distribution circuitry 108 can transition 366 the recovery relay 216 to the OFF state, transition 368 the component relay 214 to the ON state, and the transition 370 the secondary relay 218 to the ON state. After the transition 370, the operating method 300 includes determining 372 whether the secondary external power source 118 is able to provide power to the secondary external power source interface 114.

When results of the determining 372 indicate that the secondary external power source 118 is able to provide power to the secondary external power source interface 114, the operating method 300 can include the VCU 106 identifying that the charging state 404 is present and enable charging of the primary power supply 103 via the secondary power supply 104. In particular, the operating method 300 can include enabling 374 of the secondary power supply 104 and enabling 376 of the voltage converter 110. For example, when the VCU 106 identifies that the charging state 404 is present, the VCU 106 can send an enable charging signal to the charging control interface 210 to activate the voltage converter 110 to charge the primary power supply 103 via the secondary power supply 104. The power management system 100 can loop in the recovery mode operation until the secondary external power source 118 is removed or the voltage level on the primary voltage bus 201 falls below the minimum voltage level as indicated in the results of the determining 372 and the determining 364, respectively. On the occurrence of either event, the operating method 300 will move to the VCU 106 identifying the reset state 406 as present and then return to the start of the operating method 300. In particular, the operating method 300 can include disabling 378 of the secondary power supply 104 and disabling 380 of the voltage converter 110. As above, when the VCU 106 identifies that the reset state 406 is present, the VCU 106 can send a disable charging signal to the charging control interface 210 to deactivate the voltage converter 110 to stop charging of the primary power supply 103 via the secondary power supply 104.

Returning now to FIG. 4, when the result of the determining 338 indicates that the state of charge of the secondary power supply 104 is less than the preconfigured minimum charge value, the VCU 106 can refrain from entering the high voltage support mode and can proceed to determining 382 (see FIG. 6) whether the primary external power source 116 is able to provide power to the primary external power source interface 112. When the result of the determining 382 indicates that the primary external power source 116 is unable to provide power to the primary external power source interface 112, the VCU 106 directs the power management system 100 to enter the system standby mode as shown in FIG. 3. However, when the results of the determining 382 indicate that the primary external power source 116 is able to provide power to the primary external power source interface 112, the VCU 106 directs the power management system 100 to enter the tractor support mode as shown in FIG. 6.

In general, the tractor support mode enables the power management system 100 to have baseline control functionality while searching for the presence of the secondary external power source 118 and/or to enable the VCU 106 and telematics systems to alert a driver of the tractor 12 or a fleet manager that there is an issue relating to inadequate power from the primary power supply 103. When in the tractor support mode, the VCU 106 can identify that the recovery state 400 is present and direct the power distribution circuitry 108 to: 1) electrically decouple the recovery component bus 204 and the standard component bus 206 from the primary voltage bus 201; and 2) electrically couple the recovery component bus 204 to the primary external power source interface 112. In particular, the power distribution circuitry 108 can transition 384 the recovery relay 216 to the ON state, transition 386 the component relay 214 to the OFF state, and transition 388 the secondary relay 218 to the OFF state.

Thus, the tractor support mode of the power management system 100 is enabled by the master system switch being in the ON position; the primary power supply 103 having a low state of charge (e.g., <=20% of the maximum state of charge); and the secondary power supply 104 having a low state of charge remaining (e.g., has 0% of the maximum state of charge or another value appropriate value such as 5%). In the tractor support mode, the power management system 100 receives external power from the primary external power source 116. After the transition 388, the VCU 106 directs the power management system 100 to enter the recovery mode starting at the determining 372.

If the secondary external power source 118 is not found at the determining 372 operation in FIG. 6, the VCU 106 identifies the reset state 406 as present and disables 378 the secondary power supply 104 and disables 380 the voltage converter 110. The disabling 378, 380 inhibits the secondary power supply 104 and the voltage converter 110 from receiving power from the secondary external power source 118. The VCU 106 loops back to the beginning of operating method 300 and continues to operate using the primary external power source 116 until, for example, the primary power supply 103 is adequately charged and provides the predetermined minimum voltage on the primary voltage bus 201; the secondary external power source interface 114 is providing power to the secondary power supply 104; or the secondary power supply 104 has been recharged to a minimum charge value whereby the secondary power supply 104 can provide power to the primary power supply 103.

If the determination 372 indicates the secondary external power source 118 is able to provide power to the secondary power supply 104, both the primary power supply 103 and the secondary power supply 104 will begin to charge using power from the secondary external power source 118. Specifically, the secondary power supply 104 will be charged directly from the secondary external power source 118 and the primary power supply 103 will be charged indirectly via the voltage converter 110. As described above, the power management system 100 will stay in the recovery mode until the secondary external power source 118 is removed, or one of the other described conditions is reached.

In some embodiments, the transitions 366, 368, and 370 may be done at an instantaneous moment or staggered such that the recovery relay 216 is switched momentarily after the component relay 214 and secondary relay 218. This delay is performed to remove the trailer load from the tractor system as soon as possible and results in a more reliable and predictable tractor/trailer interaction. Furthermore, the delay can reduce the impact on ABS performance of the trailer system when the J560 center pin of the tractor 12 is being used as the primary external power source interface 112. Further, in embodiments where the secondary external power source 118 includes a generator of a regenerative braking system of the tractor 12 or trailer 14, the generator may be configured to generate power only when the trailer is moving at or above approximately 8-12 mph. In some embodiments, the charging start point can be set at a miles per hour value significantly higher than 8-10 mph while the charge stop point is set at approximately 8-12 mph. Setting the charging start and stop points in this manner may limit the charging operation being intermittent as the speed of the vehicle 10 varies around the set trigger values.

In general, the operating method 300 operates autonomously through the use of a cyclical check scheme by the VCU 106. This means that the VCU 106 cycles through the different operating modes at a given rate and transitions through each mode as needed based on the inputs provided at any given moment. This allows the power management system 100 to react to different inputs, changes in its operating environment, and external stimulus in real time. The autonomous nature of the operating method 300 also means that the only inputs needed from an end user is to provide external power to the power management system 100, e.g., connecting a shore power cable to a socket of the secondary external power source interface 114. In some embodiments, the power management system 100 is configured with self-monitoring, with self-managing, and to send requests when power inputs are needed. The operating method 300 also allows for maximum use of stored energy between the primary power supply 103 and secondary power supply 104 by leveraging the storage capacities of both units together. As such, the power management system 100 is capable of longer runtimes without the need for external intervention as compared with conventional power management systems. In embodiments where external power sources are used, the system automatically adapts to those power sources and uses the available power source in an efficient and minimally impactful way with respect to the onboard and external systems.

In one aspect of the present disclosure, an apparatus is provided that includes a voltage sense interface, a charging control interface, and a vehicle control unit electrically coupled to the voltage sense interface and the charging control interface. The vehicle control unit is configured to send an enable charging signal to the charging control interface when the vehicle control unit determines that a charging state is present. The vehicle control unit is further configured to transmit a disable charging signal to the charging control interface when the vehicle control unit determines that a reset state is present.

In one embodiment, the apparatus further includes a primary voltage bus; a recovery component bus electrically coupled to the vehicle control unit; a standard component bus; and a power distribution unit electrically coupled to, the primary voltage bus, the recovery component bus, and the standard component bus. When the vehicle control unit determines that a recovery state is present, the vehicle control unit is further configured to direct the power distribution unit to: electrically decouple the recovery component bus and the standard component bus from the primary voltage bus; and electrically couple the recovery component bus to a primary external power source interface. When the vehicle control unit determines that a normal state is present, the vehicle control unit is further configured to direct the power distribution unit to: electrically couple the recovery component bus and the standard component bus to the primary voltage bus; and electrically decouple the recovery component bus from the primary external power source interface.

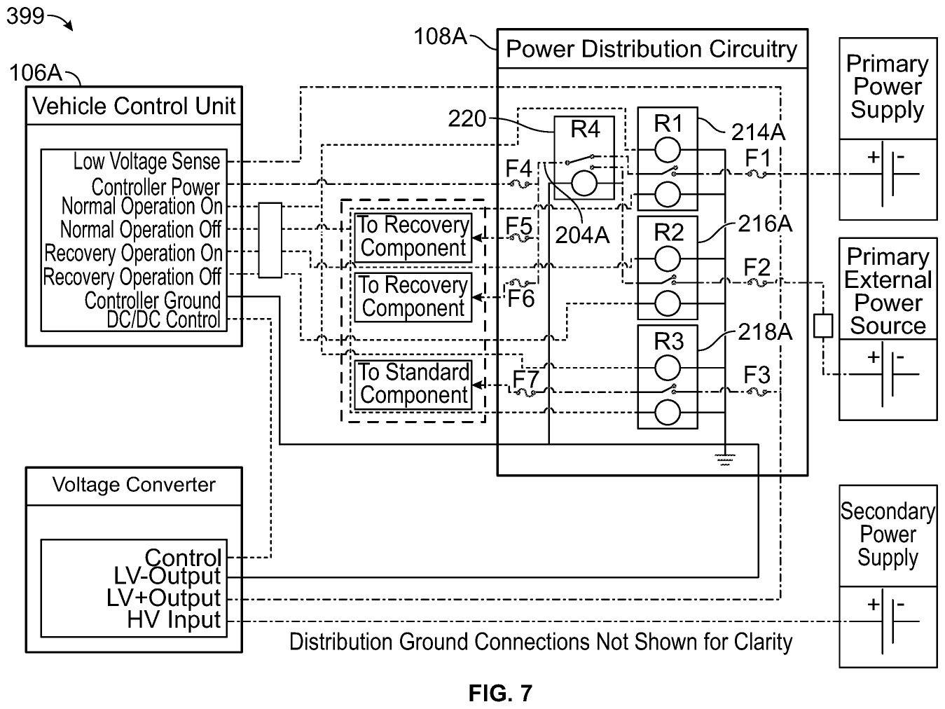

With respect to FIG. 7, a power management system 399 is provided that is similar to the power management system 100 such that similar components will be identified with similar reference numerals, with an “A” appended to the reference numeral. The power distribution circuitry 108A of the power management system 399 includes a switch such as recovery power relay 220 to connect a recovery component bus 204A to either the component relay 214A or the recovery relay 216A. The recovery power relay 220 is electrically coupled between the recovery component bus 204A on one side and the component relay 214A and recovery relay 216A on the other side. The recovery power relay 220 may be a single-pole double-throw relay operable to connect the recovery component bus 204A to one of the component relay 214A or the recovery relay 216A and disconnect the recovery component bus 204A from the other of the recovery relay 216A or the component relay 214A. The recovery power relay 220 thereby disconnects the recovery relay 216A from the component relay 214A which inhibits backfeeding of power from the recovery relay 216A to the component relay 214A and vice versa. The recovery power relay 220 also aids to continuously provide electrical power to the recovery component bus 204A when transitioning between the normal state 402 and the recovery state 400 (see FIG. 6). When transitioning between the normal state 402 and the recovery state 400, the component relay 214A and recovery relay 216A may both be in the ON state momentarily (e.g., a few milliseconds) to provide continuous power flow to the recovery component bus 204A during the transition. Thus, as the state of the recovery power relay 220 changes to connect the recovery component bus 204A to one of the component relay 214A and recovery relay 216A, power is momentarily available from both the component relay 214A and recovery relay 216A to ensure the recovery component bus 204A receives electrical power continuously as the state of the recovery power relay 220 is changed.

When operating the power distribution circuitry 108A, the VCU 106 is configured to set the recovery power relay 220 to the configuration that electrically connects the recovery component bus 204A to the desired power source, e.g., power provided through the component relay 214A or the recovery relay 216A. The configuration of the recovery power relay 220 may be set based on the state of the power management system 399. For instance, when the power management system 399 is in the recovery state 400 (see FIG. 6), the recovery power relay 220 may be set to connect the recovery component bus 204A to the recovery relay 216A and, when the power management system 399 is in the normal state 402, the recovery power relay 220 may be set to connect the recovery component bus 204A to the component relay 214A. The recovery power relay 220 may be set to connect the recovery component bus 204A to the recovery relay 216A when in the recovery component position but only when power is present and supplied by the recovery relay 216A. When in the recovery state 400, the VCU 106A may monitor whether power is being received from the primary external power source and control the recovery power relay 220 accordingly.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A, B, and C” is intended to encompass A, B, AB, BC, AC, or ABC.

While there have been illustrated and described particular embodiments of the present invention, it will be appreciated that numerous changes and modifications will occur to those skilled in the art, and it is intended for the present invention to cover all those changes and modifications which fall within the scope of the appended claims.

What is claimed is:

1. A power management apparatus for a vehicle, the power management apparatus comprising:
a primary power supply input to receive electrical power from a primary power supply of the vehicle;
a primary external power source input to receive electrical power from a primary external power source of the vehicle;
a recovery component output to provide electrical power to a recovery component of the vehicle;
a standard component output to provide electrical power to a standard component of the vehicle;
power distribution circuitry operatively connecting the primary power supply input, the primary external power source input, the recovery component output, and the standard component output, the power distribution circuitry having:
an operating configuration wherein the power distribution circuitry:
electrically connects the primary power supply input to the recovery component output and the standard component output to provide electrical power from the primary power supply to the recovery component and the standard component; and
inhibits a flow of electrical power from the primary external power source input to the recovery component output; and
a recovery configuration wherein the power distribution circuitry:
electrically connects the primary external power source input to the recovery component output to provide electrical power from the primary external power source to the recovery component; and
inhibits a flow of electrical power from the primary power supply input to the standard component output and the recovery component output.

2. The power management apparatus of claim 1 wherein the power distribution circuitry inhibits the flow of electrical power between the primary power supply input and the primary external power source input with the power distribution circuitry in the operating configuration and the recovery configuration.

3. The power management apparatus of claim 1 further comprising a vehicle control unit operably coupled to the power distribution circuitry, the vehicle control unit configured to:
detect whether electrical power is available for the recovery component and standard component from the primary power supply input;
cause the power distribution circuitry to be in the operating configuration when electrical power is available from the primary power supply input; and
cause the power distribution circuitry to be in the recovery configuration when electrical power is unavailable from the primary power supply input.

4. The power management apparatus of claim 3 wherein to detect whether electrical power is available from the primary power supply input includes measuring a voltage of the primary power supply.

5. The power management apparatus of claim 3 further comprising a voltage bus connected to the primary power supply input;
wherein the vehicle control unit is configured to determine whether electrical power is available from a secondary power supply of the vehicle; and
wherein the vehicle control unit is further configured to cause electrical power of the secondary power supply to be provided to the voltage bus when electrical power is available from the secondary power supply to charge the primary power supply.

6. The power management apparatus of claim 1 further comprising a vehicle control unit operably coupled to the power distribution circuitry;
wherein the primary power supply input is further configured to receive electrical power from a secondary power supply of the vehicle; and
wherein the vehicle control unit is configured to:
detect when a charge variable of the primary power supply is below a threshold;
determine whether electrical power is available from the secondary power supply;
upon determining electrical power is available from the secondary power supply, cause electrical power of the secondary power supply to be provided to the primary power supply input for a period of time to electrically power the recovery component and standard component and to charge the primary power supply;
upon expiration of the period of time, causing the secondary power supply to stop providing electrical power to the primary power supply input; and
detecting the charge variable of the primary power supply upon causing the secondary power supply to stop providing electrical power to the primary power supply.

7. The power management apparatus of claim 1 in combination with the primary power supply and the recovery component, the primary power supply including a battery; and
wherein the recovery component includes battery charging circuitry operable to charge the battery.

8. The power management apparatus of claim 1 wherein the primary external power source input includes a primary external power source interface configured to connect to an anti-lock braking system of the vehicle and receive electrical power from the anti-lock braking system.

9. The power management apparatus of claim 1 wherein the power distribution circuitry includes a plurality of relays operable to set the power distribution circuitry in the operating configuration or the recovery configuration.

10. The power management apparatus of claim 9 wherein the plurality of relays are bi-stable relays to maintain the power distribution circuitry in the operating configuration or the recovery configuration without electrical power.

11. The power management apparatus of claim 1 wherein the power distribution circuitry includes:
a first relay operable to electrically connect the primary power supply input to the recovery component output;
a second relay operable to electrically connect the primary external power source input to the recovery component output; and
a third relay operable to electrically connect the primary power supply input to the standard component output.

12. The power management apparatus of claim 11 wherein with the power distribution circuitry in the operating configuration, the second relay inhibits the flow of electrical power between the primary external power source input and the recovery component output; and
wherein with the power distribution circuitry in the recovery configuration, the first relay inhibits the flow of electrical power between the primary power supply input and the recovery component output and the third relay inhibits the flow of electrical power between the primary power supply input and the standard component output.

13. The power management apparatus of claim 1 in combination with the primary power supply, wherein the primary power supply is a first battery having a first voltage;
a voltage bus connected to the primary power supply input;
a voltage converter having a high voltage input to receive electrical power from a second battery having a second voltage higher than the first voltage and a low voltage output connected to the voltage bus to provide electrical power at the first voltage to the voltage bus.

14. The power management apparatus of claim 1 in combination with the recovery component, wherein the recovery component includes at least one of:
a vehicle control unit;
battery charging circuitry;
power conversion circuitry;
safety monitoring devices;
isolation monitors; and
user feedback components.

15. The power management apparatus of claim 1 in combination with the standard component, wherein the standard component includes at least one of:
a light of the vehicle;
a pump of the vehicle;
a fan of the vehicle;
a display of the vehicle;
an electric power take-off of the vehicle; and
an electric motor of the vehicle.

16. A vehicle comprising:
a primary power supply;
a primary external power source interface to be connected to a primary external power source;
a recovery component;
a standard component;
a power management apparatus operatively connected to the primary power supply, the primary external power source interface, the recovery component, and the standard component, the power management apparatus configured to:
facilitate the recovery component and the standard component receiving electrical power from the primary power supply and inhibit a flow of electrical power from the primary external power source interface to the recovery component based at least in part upon electrical power being available from the primary power supply for the recovery component and the standard component; and
facilitate the recovery component receiving electrical power from the primary external power source interface and inhibit a flow of electrical power from the primary power supply to the recovery component and the standard component based at least in part upon the electrical power being unavailable from the primary power supply for the recovery component and the standard component.

17. The vehicle of claim 16 wherein the power management apparatus comprises a processor configured to determine whether electrical power is available from the primary power supply for the recovery component and the standard component based at least in part upon a variable of the primary power supply.

18. The vehicle of claim 17 wherein to determine whether electrical power is available from the primary power supply includes measuring a voltage of the primary power supply.

19. The vehicle of claim 16 further comprising a secondary power supply;
wherein the power management apparatus includes a voltage bus connected to the primary power supply; and
wherein the power management apparatus is further configured to:
cause electrical power of the secondary power supply to be provided to the voltage bus to charge the primary power supply and to provide electrical power to the recovery component and standard component based at least in part upon electrical power being available from the secondary power supply.

20. The vehicle of claim 16 wherein to facilitate the recovery component and the standard component receiving electrical power from the primary power supply includes inhibiting electrical power from flowing between the primary power supply and the primary external power source; and
wherein to facilitate the recovery component receiving electrical power from the primary external power source interface includes inhibiting electrical power from flowing between the primary power supply and the primary external power source.

21. The vehicle of claim 16 wherein the primary power supply includes a battery and the recovery component includes battery charging circuitry operable to charge the battery.

22. The vehicle of claim 16 wherein the recovery component includes battery charging circuitry to be connected to a secondary external power source;
wherein the power management apparatus is further configured to facilitate charging of the primary power supply with the battery charging circuitry when the battery charging circuitry is connected to the secondary external power source.

23. The vehicle of claim 16 wherein the vehicle is a trailer and the primary external power source interface includes an electrical connector to connect to a corresponding electrical connector of a tractor.

24. The vehicle of claim 16 wherein the primary external power source interface is configured to connect to an anti-lock braking system and receive electrical power therefrom.

25. The vehicle of claim 16 wherein the power management apparatus includes a plurality of relays operable to facilitate or inhibit the recovery component and standard component receiving electrical power from the primary power supply and to facilitate or inhibit the recovery component receiving electrical power from the primary external power source interface.

26. The vehicle of claim 16 wherein the power management apparatus comprises a vehicle control unit operatively connected to power distribution circuitry, wherein the power distribution circuitry comprises a first relay, a second relay, and a third relay;
wherein the vehicle control unit is configured to cause the second relay to inhibit a flow of electrical power between the primary external power source interface and the recovery component based at least in part upon electrical power being available from the primary power supply for the recovery component and the standard component; and
wherein the vehicle control unit is configured to cause the first relay to inhibit a flow of electrical power between the primary power supply and the recovery component and cause the third relay to inhibit flow of electrical power between the primary power supply and the standard component based at least in part upon electrical power being unavailable from the primary power supply for the recovery component and the standard component.

27. The vehicle of claim 16 wherein the primary power supply includes a first battery having a first voltage, the vehicle further comprising a voltage converter and a secondary power supply including a second battery having a second voltage higher than the first voltage,
wherein the power management apparatus is operable to cause the voltage converter to provide electrical power from the second battery to the first battery, the recovery component, and the standard component.

28. The vehicle of claim 16 further comprising a secondary power supply, wherein the power management apparatus is operatively connected to the secondary power supply and further configured to:
detect a charge variable of the primary power supply being below a threshold;
determine whether electrical power is available from the secondary power supply to charge the primary power supply;
upon determining electrical power is available from the secondary power supply, cause electrical power of the secondary power supply to be provided to the primary power supply for a period of time to charge the primary power supply; and
upon expiration of the period of time, ceasing to provide electrical power of the secondary power supply to the primary power supply; and
detecting the charge variable of the primary power supply upon ceasing to provide electrical power of the secondary power supply to the primary power supply.

29. The vehicle of claim 16 wherein the recovery component of the vehicle includes at least one of:
a vehicle control unit;
battery charging circuitry;
power conversion circuitry;
safety monitoring devices;
isolation monitors; and
user feedback components.

30. The vehicle of claim 16 wherein the standard component includes at least one of:
a light;
a pump;
a fan;
a display;
an electric power take-off; and
an electric motor.

31. The vehicle of claim 16 in combination with the primary external power source of the vehicle, the primary external power source comprising an ignition power source of the vehicle.

32. A method of managing power in a vehicle including a primary power supply, a recovery component, a standard component, and a primary external power source, the method comprising:
determining whether electrical power is available from the primary power supply of the vehicle to power the standard component and the recovery component;
facilitating the standard component and the recovery component receiving electrical power from the primary power supply and inhibiting a flow of electrical power from the primary external power source to the recovery component based at least in part upon the electrical power being available from the primary power supply to power the standard component and the recovery component; and
facilitating the recovery component receiving electrical power from the primary external power source and inhibiting a flow of electrical power from the primary power supply to the recovery component and the standard component based at least in part upon the electrical power being unavailable from the primary power supply to power the standard component and the recovery component.

33. The method of claim 32 further comprising:
determining whether electrical power is available from a secondary power supply of the vehicle; and
causing electrical power of the secondary power supply to be provided to a voltage bus of the primary power supply to charge the primary power supply and to provide electrical power to the recovery component and standard component based at least in part on the electrical power being available from the secondary power supply.

34. The method of claim 33 wherein causing electrical power of the secondary power supply to be provided to the voltage bus includes operating a voltage converter to provide electrical power from the secondary power supply to the voltage bus.

35. The method of claim 32 wherein facilitating the standard component and the recovery component receiving electrical power from the primary power supply comprises inhibiting electrical power from flowing between the primary power supply and the primary external power source; and
wherein facilitating the recovery component receiving electrical power from the primary external power source comprises inhibiting electrical power from flowing between the primary power supply and the primary external power source.

36. The method of claim 32 wherein the primary power supply includes a battery and the recovery component includes battery charging circuitry, the method further comprising charging the battery with the battery charging circuitry based at least in part on electrical power being available to the battery charging circuitry.

37. The method of claim 32 wherein the vehicle further comprises a secondary power supply, the method further comprising:
detecting when a charge variable of the primary power supply is below a threshold;
determining whether electrical power is available from the secondary power supply to charge the primary power supply;
upon determining electrical power is available from the secondary power supply, causing electrical power of the secondary power supply to be provided to the primary power supply for a period of time to charge the primary power supply;
upon expiration of the period of time, ceasing to provide electrical power of the secondary power supply to the primary power supply; and
detecting the charge variable of the primary power supply upon ceasing to provide electrical power of the secondary power supply to the primary power supply.

38. The method of claim 32 wherein determining whether electrical power is available from the primary power supply includes measuring a variable of the primary power supply.

39. The method of claim 32 wherein the vehicle comprises a tractor and a trailer;
wherein the primary external power source comprises an anti-lock braking system of the tractor.

40. The method of claim 32 wherein facilitating or inhibiting the recovery component and standard component receiving electrical power from the primary power supply and facilitating or inhibiting the recovery component receiving electrical power from the primary external power source includes operating a plurality of relays.

41. The method of claim 32 wherein facilitating the standard component and the recovery component receiving electrical power from the primary power supply includes:
causing a first relay to electrically connect the primary power supply to the recovery component; and
causing a third relay to electrically connect the primary power supply to the standard component; and
wherein inhibiting flow of electrical power from the primary external power source to the recovery component includes causing a second relay to electrically disconnect the primary external power source from the recovery component.

42. The method of claim 41 wherein facilitating the recovery component receiving electrical power from the primary external power source includes causing the second relay to electrically connect the primary external power source to the recovery component; and
wherein inhibiting the flow of electrical power from the primary power supply to the recovery component and the standard component includes:
causing the first relay to electrically disconnect the primary power supply and the recovery component from the primary power supply; and
causing the third relay to electrically disconnect the primary power supply and the standard component.
